(19) United States
(12) Patent Application Publication
(10) Pub. No.: US 2024/0300347 A1
(43) Pub. Date: Sep. 12, 2024

(54) ELECTRONIC DEVICE MODULE AND POWER SYSTEM

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventors: Yuki FUJIMURA, Osaka-shi, Osaka (JP); Yusuke ISAJI, Osaka-shi, Osaka (JP); Yoshiyuki USUI, Osaka-shi, Osaka (JP); Masato TSUTSUKI, Osaka-shi, Osaka (JP)

(21) Appl. No.: 18/264,051

(22) PCT Filed: Jan. 17, 2022
(86) PCT No.: PCT/JP2022/001297

§ 371 Date: Aug. 2, 2023

(30) Foreign Application Priority Data
Feb. 5, 2021 (JP) 2021-017349
Mar. 26, 2021 (JP) 2021-053329

(51) Int. Cl. B60L 53/22; B60K 11/02; B60L 53/10; B60L 53/16; H01M 10/46; H01M 10/613; H01M 10/625; H01M 10/656

(52) U.S. Cl. CPC B60L 53/22; B60K 11/02; B60L 53/11; B60L 53/16; H01M 10/46; H01M 10/613; H01M 10/625; H01M 10/656; B60L 2210/10; B60L 2210/40; H01M 2220/20

(57) ABSTRACT

An electronic device module that is connected to a battery pack including a high voltage battery is provided with a conductive path electrically connected to the battery pack, a branch part electrically connected to the conductive path, a plurality of branch paths electrically connected to the branch part, a circuit board electrically connected to at least one of the plurality of branch paths, and a plurality of branch connectors electrically connected to the plurality of branch paths, the circuit board including a plurality of power conversion units that convert power.

### CROSS-REFERENCE TO RELATED APPLICATIONS

This application is the U.S. national stage of PCT/JP2022/001297 filed on Jan. 17, 2022, which claims priority of Japanese Patent Application No. 2021-017349 filed on Feb. 5, 2021, and Japanese Patent Application No. 2021-053329, filed on Mar. 26, 2021, the contents of which are incorporated herein.

### TECHNICAL FIELD

The present disclosure relates to an electronic device module and a power system.

### BACKGROUND

Heretofore, a known power system that is installed in a vehicle such as an electric car or a hybrid car and functions to distribute and control power is described in JP 2008-30722A. The above power system is provided with a battery device. A DC/DC converter and an auxiliary battery are connected to the battery device. Although not shown in detail, a DC charging connector for quickly charging the battery device, an AC charging connector for charging from a household power source having a voltage of 100 V, an AC output connector for supplying alternating current having a voltage of 100 V inside the vehicle, a plurality of electrical devices installed in the vehicle, and the like are electrically connected to the battery device.

In recent years, the number of electrical devices that are installed in vehicles is increasing as vehicles become more sophisticated. The workload for connecting the electrical devices to the battery device thereby increases.

The present disclosure has been completed based on circumstances such as the above, and an object of the disclosure is to provide an electronic device module and a power system that enable the connection workload to be reduced.

### SUMMARY

The present disclosure relates to an electronic device module for connecting to a battery pack including a high voltage battery, the electronic device module including a conductive path configured to be electrically connected to the battery pack, a branch part electrically connected to the conductive path, a plurality of branch paths electrically connected to the branch part, a circuit board electrically connected to at least one of the plurality of branch paths, and a plurality of branch connectors electrically connected to the plurality of branch paths, and the circuit board including a plurality of power conversion units configured to convert power.

### Advantageous Effects

According to the present disclosure, the workload for connecting a plurality of power conversion units to a battery pack can be reduced in an electronic device module and a power system.

### BRIEF DESCRIPTION OF DRAWINGS

FIG. 1 is a schematic diagram showing a vehicle according to Embodiment 1 of the present disclosure.

FIG. 2 is a block diagram showing a configuration of a power system.

FIG. 3 is a partially enlarged cross-sectional view showing a power source connector and a device connector.

FIG. 4 is a block diagram showing a power system according to Embodiment 2 of the present disclosure.

FIG. 5 is a block diagram showing a power system according to Embodiment 3 of the present disclosure.

FIG. 6 is a block diagram showing a power system according to Embodiment 4 of the present disclosure.

FIG. 7 is a block diagram showing a power system according to Embodiment 5 of the present disclosure.

FIG. 8 is a perspective view showing a power system according to Embodiment 6.

FIG. 9 is a cross-sectional view showing the power system.

FIG. 10 is a perspective view showing a battery cooling unit and a module cooling unit that are integrally formed.

FIG. 11 is a plan view showing the power system.

FIG. 12 is a perspective view showing a power system according to Embodiment 7.

FIG. 13 is a perspective view showing a battery cooling unit and a module cooling unit.

FIG. 14 is a plan view showing the power system.

### DETAILED DESCRIPTION OF PREFERRED EMBODIMENTS

Initially, modes of the present disclosure will be enumerated and described.

The present disclosure relates to an electronic device module for connecting to a battery pack including a high voltage battery, the electronic device module including a conductive path configured to be electrically connected to the battery pack, a branch part electrically connected to the conductive path, a plurality of branch paths electrically connected to the branch part, a circuit board electrically connected to at least one of the plurality of branch paths, and a plurality of branch connectors electrically connected to the plurality of branch paths, and the circuit board including a plurality of power conversion units configured to convert power.

A plurality of electrical devices installed in the vehicle can be electrically connected to a battery pack, by connecting wiring harnesses routed from the plurality of electrical devices to the branch connectors provided in the electronic device module. The workload for connecting the plurality of electrical devices to the battery pack can thereby be reduced, compared to the case where the plurality of electrical devices are individually connected to the battery pack.

Preferably, the plurality of power conversion units are one or more of an onboard charger configured to be used for charging the high voltage battery, a DC/AC conversion unit configured to convert direct current from the high voltage battery into alternating current, and a DC/DC conversion unit configured to convert a voltage of the direct current from the high voltage battery.

By connecting the battery pack to the electronic device module, one or more of the onboard charger, the DC/AC conversion unit and the DC/DC conversion unit can be connected to the high voltage battery, thus enabling the connection workload to be reduced, compared to the case where the onboard charger, the DC/AC conversion unit and the DC/DC conversion unit are each connected to the battery pack.

Preferably, the electronic device module includes a power source control unit configured to control the high voltage battery.

The high voltage battery can be connected to the power source control unit, by connecting the DC power supply to the electronic device module, thus enabling the workload for connecting the high voltage battery to the power source control unit to be reduced.

Preferably, the electronic device module includes a branch connector configured to be electrically connected to a quick charger for quickly charging the high voltage battery, and a quick charging path connecting the branch connector to the conductive path configured to be electrically connected to the battery pack.

The branch part for branching power from the high voltage battery pack and the quick charging path for branching power from the high voltage battery pack to a quick charger can be formed together in the electronic device module, thus enabling the electronic device module to be efficiently manufactured.

The present disclosure relates to a power system including the electronic device module according to any one of (1) to (4) above, and a battery pack connected to the electronic device module and including a high voltage battery.

Preferably, the battery pack includes a power source connector, the electronic device module includes a device connector fitted together with the power source connector in a fitting direction, the power source connector includes a power source terminal including a power source connection part extending in a direction intersecting the fitting direction, the device connector includes a device terminal including a device connection part extending in a direction intersecting the fitting direction, and the power source terminal and the device terminal are electrically connected due to the power source connection part and the device connection part elastically contacting each other.

The battery pack can be electrically connected to the electronic device module, by fitting the power source connector together with the device connector in the fitting direction, thus enabling the efficiency of the task of connecting the battery pack to the electronic device module to be improved.

Also, a wiring harness for connecting the battery pack to the electronic device module is not required, thus enabling the power system to be downsized.

Preferably, the battery pack is in heat transferable contact with a battery cooling unit configured to cool the battery pack, the battery cooling unit is provided with a first flow path through which a coolant flows, the electronic device module is in heat transferable contact with a module cooling unit configured to cool the electronic device module, and the module cooling unit is provided with a second flow path into which the coolant flowing out from the first flow path of the battery cooling unit flows.

Heat generated by the power storage element is transferred from the battery pack to the battery cooling unit, and is transferred to the coolant flowing inside the first flow path provided in the battery cooling unit. The temperature of the power storage element can thereby be lowered. Next, the coolant flowing out from the first flow path flows into the second flow path. In the module cooling unit in which the second flow path is provided, heat generated by the electronic device module is transferred from the electronic device module to the module cooling unit, and is thereafter transferred to the coolant flowing inside the second flow path. The temperature of the electronic device module can thereby be reduced. In the present disclosure, the coolant in the module cooling unit for cooling the electronic device module can also be used in the battery cooling unit as a coolant for cooling the power storage element. The electronic device module can thereby be efficiently cooled.

Preferably, the battery cooling unit and the module cooling unit are integrally formed. The number of components can thereby be reduced.

Preferably, the battery cooling unit and the module cooling unit are separate components, the battery cooling unit includes a first inflow port through which the coolant flows into the first flow path and a first outflow port through which the coolant flows out from the first flow path, and the module cooling unit includes a second inflow port through which the coolant flowing out through the first outflow port flows into the second flow path and a second outflow port through which the coolant flows out from the second flow path.

According to the above configuration, the battery pack and the battery cooling unit can be disposed in a different place to the electronic device module and the module cooling unit. Design freedom can thereby be improved with regard to the disposition of the battery pack and battery cooling unit and the electronic device module and module cooling unit.

Also, the electronic device module is cooled by the coolant flowing out from the first flow path of the battery cooling unit that cools the power storage element, thus enabling a reduction in the cooling efficiency of the power storage element to be suppressed.

Hereinafter, embodiments of the present disclosure will be described. The present disclosure is not limited to these illustrative examples and is defined by the claims, and all changes that come within the meaning and range of equivalency of the claims are intended to be embraced therein.

### Embodiment 1

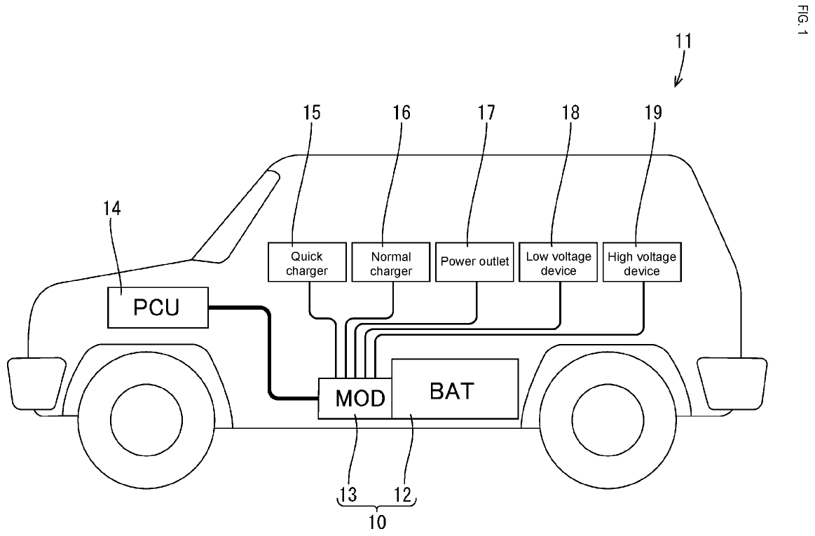

Embodiment 1 of the present disclosure will be described with reference to FIGS. 1 to 3. A power system 10 according to the present embodiment is installed in a vehicle such as an electric car or a hybrid car, for example. As shown in FIG. 1, a battery pack 12, an electronic device module 13, a PCU 14 (Power Control Unit), a quick charger 15, a normal charger 16, an AC power outlet 17, a low voltage device 18, and high voltage devices 19 are installed in a vehicle 11. The power system 10 according to the present embodiment is provided with the battery pack 12 which includes a high voltage battery 20 and the electronic device module 13 which is connected to the battery pack 12. In the following description, reference numerals may to given to only some of a plurality of members that are the same and not to all of the members.

### Power System 10

As shown in FIG. 1, the battery pack 12 is electrically connected to the electronic device module 13. The electronic device module 13 is electrically connected to the PCU 14, the quick charger 15, the normal charger 16, the power outlet 17, the low voltage device 18 and the high voltage devices 19. The low voltage device 18 includes a low voltage battery 24. The high voltage devices 19 include a compressor 21 for an air conditioner, a water heater 22, and another optional device 23. The high voltage devices 19 are not limited to the above-described devices.

### Battery Pack 12

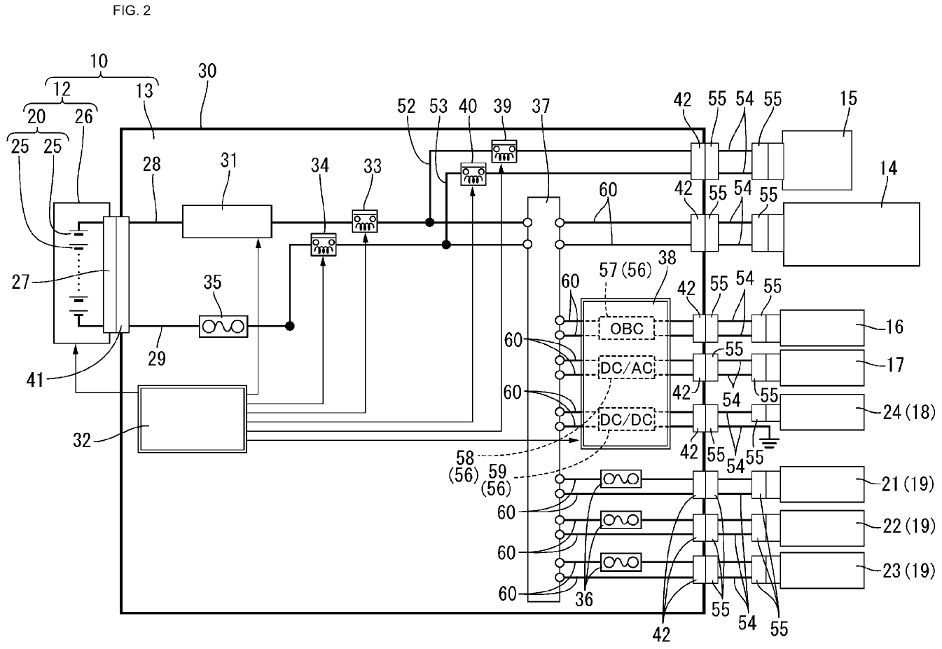

As shown in FIG. 2, the high voltage battery 20 includes a plurality of power storage elements 25. Any suitable power storage element, such as a lithium-ion battery, for example, can be selected as appropriate as the power storage elements 25. The high voltage battery 20 is used as a drive source of the vehicle 11 and outputs a high voltage (e.g., approx. 300 V). The output voltage of the high voltage battery 20 when fully charged is higher than the output voltage (e.g., approx. 12 V) of the low voltage battery 24 when fully charged.

As shown in FIG. 2, the battery pack 12 includes a case 26, and the case 26 houses the high voltage battery 20. A power source connector 27 is attached to the case 26. The power source connector 27 is electrically connected to the high voltage battery 20.

A first conductive path 28 is electrically connected to a cathode of the high voltage battery 20, and a second conductive path 29 is electrically connected to an anode of the high voltage battery 20.

### Electronic Device Module 13

As shown in FIG. 2, the electronic device module 13 includes a case 30, and the case 30 houses a current sensor 31, a power source control unit 32, a first system main relay 33, a second system main relay 34, a main fuse 35, fuses 36, a branch part 37, a circuit board 38, a first quick charging relay 39 and a second quick charging relay 40. A device connector 41 that can be fitted together with the power source connector 27 is attached to the case 30. Also, a plurality of branch connectors 42 that are electrically connected to the PCU 14, the quick charger 15, the normal charger 16, the power outlet 17, the low voltage device 18 and the high voltage devices 19 are attached to the case 30.

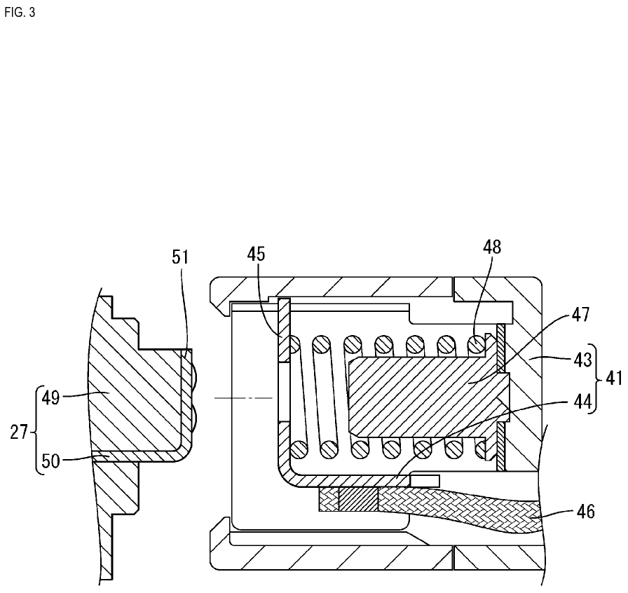

As shown in FIG. 3, the device connector 41 includes an insulating synthetic resin device connector housing 43 and a metal device terminal 44. The device terminal 44 is formed by pressing a conductive metal plate material into a predetermined shape. The device terminal 44 includes a device connection part 45 that extends in a direction intersecting the fitting direction in which the power source connector 27 and the device connector 41 are fitted together. The device connection part 45 is provided at a front end of the device terminal 44 in the fitting direction of the device connector 41. A flexible conductor 46 having flexibility is connected to a rear end of the device terminal 44. The flexible conductor 46 is composed of a braided wire in which fine metal wires are braided.

The device connector housing 43 includes a shaft part 47 that extends forward in the fitting direction of the device connector 41. The shaft part 47 has a solid columnar shape. A coil spring 48 is fitted on the outer periphery of the shaft part 47. The device connection part 45 of the device terminal 44 is in contact with a front end of the coil spring 48 from the front in the fitting direction of the device connector 41.

As shown in FIG. 3, the power source connector 27 includes an insulating synthetic resin power source connector housing 49 and a metal power source terminal 50. The power source terminal 50 is formed by pressing a metal plate into a predetermined shape. The power source terminal 50 includes a power source connection part 51 that extends in a direction intersecting the fitting direction in which the power source connector 27 and the device connector 41 are fitted together.

When the power source connector 27 and the device connector 41 are fitted together, the power source connection part 51 of the power source terminal 50 contacts the device connection part 45 of the device terminal 44. At this time, the power source connection part 51 is in intimate contact with the device connection part 45, due to the coil spring 48 elastically pressing the device connection part 45 from the rear in the fitting direction of the device connector 41. The power source terminal 50 is thereby electrically connected the device terminal 44.

As shown in FIG. 2, the power source connector 27 and the first conductive path 28 which is connected to the cathode of the high voltage battery 20 via the device connector 41 are arranged in the electronic device module 13. The first conductive path 28 is an example of a conductive path configured to be electrically connected to the battery pack 12. The current sensor 31 and the first system main relay 33 are connected in series on the first conductive path 28. The current sensor 31 is arranged between the device connector 41 and the first system main relay 33. The current sensor 31 detects a current flowing through the first conductive path 28. The current detected by the current sensor 31 is transmitted to the power source control unit 32. The first system main relay 33 is switched to either a conduction (on) state or an open (off) state by a signal from the power source control unit 32.

As shown in FIG. 2, the second conductive path 29 that is connected to the anode of the high voltage battery 20 via the power source connector 27 and the device connector 41 is arranged in the electronic device module 13. The second conductive path 29 is an example of a conductive path configured to be electrically connected to the battery pack 12. The main fuse 35 and the second system main relay 34 are connected in series on the second conductive path 29. The main fuse 35 cuts off overcurrent, by opening the second conductive path 29 when an overcurrent flows through the second conductive path 29. The second system main relay 34 is switched to either a conduction (on) state or an open (off) state by a signal from the power source control unit 32.

The branch part 37 is electrically connected to a position of the first system main relay 33 on an opposite side to the current sensor 31 on the first conductive path 28, and to a position on an opposite side of the second system main relay 34 to the main fuse 35 on the second conductive path 29. The branch part 37 electrically connects the first conductive path 28 and the second conductive path 29 that are connected to the high voltage battery 20 to the charger 16, the power outlet 17, the low voltage battery 24, the compressor 21, the water heater 22 and the optional device 23. A plurality of branch paths 60 lead out from the branch part 37. The plurality of branch paths 60 are respectively electrically connected to the PCU 14, the circuit board 38, the compressor 21, the water heater 22 and the optional device 23.

On the first conductive path 28, a first quick charging path 52 branches off between the first system main relay 33 and the branch part 37. Also, on the second conductive path 29, a second quick charging path 53 branches off between the second system main relay 34 and the branch part 37. The first quick charging path 52 and the second quick charging path 53 are electrically connected to the quick charger 15.

The first quick charging relay 39 is connected to the first quick charging path 52, and the second quick charging relay 40 is connected to the second quick charging path 53. The first quick charging relay 39 and the second quick charging relay 40 are switched to either a conduction (on) state or an open (off) state, by a signal from the power source control unit 32.

The first quick charging path 52 and the second quick charging path 53 are connected to a branch connector 42. The branch connector 42 is connected to a connector 55 connected to one end of a wiring harness 54. A connector 55 connected to the other end of the wiring harness 54 is connected to the quick charger 15. Power is thereby supplied from the quick charger 15 to the high voltage battery 20.

### Branch Part 37

As shown in FIG. 2, two branch paths 60 that are connected to the PCU 14 are electrically connected to the branch part 37. The branch paths 60 are connected to a branch connector 42. The branch connector 42 is connected to a connector 55 connected to one end of a wiring harness 54. A connector 55 connected to the other end of the wiring harness 54 is connected to the PCU 14. Power is thereby supplied from the high voltage battery 20 to the PCU 14.

The PCU 14 converts output power from the high voltage battery 20 into power for driving a motor (not shown) and supplies the resultant power to the motor. The PCU 14 is provided with an inverter (not shown), for example, and functions to generate alternating current or three-phase alternating current from the direct current and supply the resultant current to the motor.

Two branch paths 60 that are connected to the compressor 21 are electrically connected to the branch part 37. The branch paths 60 are connected to a branch connector 42. The branch connector 42 is connected to a connector 55 connected to one end of a wiring harness 54. A connector 55 connected to the other end of the wiring harness 54 is connected to the compressor 21. Power is thereby supplied from the high voltage battery 20 to the compressor 21. A fuse 36 is connected in series on one of the two branch paths 60. The fuse 36 cuts off overcurrent by blowing when an overcurrent flows through the branch path 60.

Two branch paths 60 that are connected to the water heater 22 are electrically connected to the branch part 37. The branch paths 60 are connected to a branch connector 42. The branch connector 42 is connected to a connector 55 connected to one end of a wiring harness 54. A connector 55 connected to the other end of the wiring harness 54 is connected to the water heater 22. Power is thereby supplied from the high voltage battery 20 to the water heater 22. Due to the power supplied from the high voltage battery 20, the water heater 22 heats water. A fuse 36 is connected in series on one of the two branch paths 60. The fuse 36 cuts off overcurrent by blowing when an overcurrent flows through the branch path of the water heater 22.

Two branch paths 60 that are connected to the optional device 23 are electrically connected to the branch part 37. The branch paths 60 are connected to a branch connector 42. The branch connector 42 is connected to a connector 55 connected to one end of a wiring harness 54. A connector 55 connected to the other end of the wiring harness 54 is connected to the optional device 23. Power is thereby supplied from the high voltage battery 20 to the optional device 23. The optional device 23 exhibits various functions due to the power supplied from the high voltage battery 20. A fuse 36 is connected in series on one of the two branch paths 60. The fuse 36 cuts off overcurrent by blowing when an overcurrent flows through the branch path of the optional device 23.

### Circuit Board 38

As shown in FIG. 2, the circuit board 38 is electrically connected to the branch part 37. The circuit board 38 has a conductive pattern (not shown) formed by a printed wiring technology. The circuit board 38 includes a plurality of power conversion units 56. The power conversion units 56 have any suitable function, such as converting direct current into alternating current, converting alternating current into direct current, or stepping direct current up or down. In the present embodiment, the circuit board 38 includes an onboard charger 57 that converts a household AC power source into direct current, a DC/AC conversion unit 58 that converts direct current into 100 V alternating current, and a DC/DC conversion unit 59 that steps down the direct current of the high voltage battery 20 to the voltage of the low voltage battery 24. The onboard charger 57, the DC/AC conversion unit 58 and the DC/DC conversion unit 59 are examples of the power conversion units 56.

Branch paths 60 that are electrically connected to the onboard charger 57 of the circuit board 38 are connected to the branch part 37. The onboard charger 57 and a branch connector 42 are connected in series on the branch paths 60. The branch connector 42 is connected to a connector 55 connected to one end of a wiring harness 54. A connector 55 connected to the other end of the wiring harness 54 is connected to the normal charger 16. The normal charger 16 is formed to be connectable to a household AC power source. When the normal charger 16 is connected to a household AC power source, the onboard charger 57 converts the household alternating current into direct current and steps up the direct current to a predetermined voltage. Power is thereby supplied from the household AC power supply to the high voltage battery 20.

Branch paths 60 that are electrically connected to the DC/AC conversion unit 58 of the circuit board 38 are connected to the branch part 37. The DC/AC conversion unit 58 and a branch connector 42 are connected in series on the branch paths 60. The branch connector 42 is connected to a connector 55 connected to one end of a wiring harness 54. A connector 55 connected to the other end of the wiring harness 54 is connected to the 100 V power outlet 17 attached inside a vehicle cabin. The 100 V power outlet 17 has the same shape as a known household AC power source. When an electrical device (not shown) is connected to the power outlet 17, the DC/AC conversion unit 58 converts the direct current from the high voltage battery 20 into 100 V alternating current and supplies the 100 V alternating current to the electrical device.

Branch paths 60 that are electrically connected to the DC/DC conversion unit 59 of the circuit board 38 are connected to the branch part 37. The DC/DC conversion unit 59 and a branch connector 42 are connected in series on the branch paths 60. The branch connector 42 is connected to a connector 55 connected to one end of a wiring harness 54. The wiring harness 54 has two wires. A connector 55 connected to one of the wires is electrically connected to the low voltage battery 24. The other wire has a ground potential due to being connected to a body of the vehicle 11. The DC/AC conversion unit 58 steps down the direct current from the high voltage battery 20 to 12 V and supplies the 12 V direct current to the low voltage battery 24.

The low voltage battery 24 may be constituted by a lead-acid battery, a lithium-ion battery, or another type of storage battery.

### Power Source Control Unit 32

As shown in FIG. 2, the electronic device module 13 includes the power source control unit 32. The power source control unit 32 is capable of communicating by cable or wirelessly with the high voltage battery 20, the current sensor 31, the first system main relay 33, the second system main relay 34, the first quick charging relay 39, the second quick charging relay 40 and the circuit board 38. The power source control unit 32 is capable of communicating with the onboard charger 57, the DC/AC conversion unit 58 and the DC/DC conversion unit 59 provided on the circuit board 38, by communicating with the circuit board 38. The power source control unit 32 receives information from the high voltage battery 20, the current sensor 31, the first system main relay 33, the second system main relay 34, the first quick charging relay 39, the second quick charging relay 40, the onboard charger 57, the DC/AC conversion unit 58 and the DC/DC conversion unit 59, and controls the onboard charger 57, the DC/AC conversion unit 58 and the DC/DC conversion unit 59, based on this information.

### Process for Assembling Power System 10 to Vehicle 11

Next, an example of a process for assembling the power system 10 according to the present embodiment to the vehicle 11 will be shown. The process for assembling the power system 10 to the vehicle 11 is not limited to the following description.

The battery pack 12 is fixed to the vehicle 11 by a known technique such as bolting. The power source connector 27 of the battery pack 12 and the device connector 41 of the electronic device module 13 are brought close together. When the power source connector 27 and the device connector 41 start to fit together, the power source connection part 51 of the power source terminal 50 comes into contact with the device connection part 45 of the device terminal 44. Furthermore, when the power source connector 27 and the device connector 41 are brought closer together, the device terminal 44 is pressed against the power source terminal 50 by the coil spring 48. When the power source connector 27 and the device connector 41 are completely fitted together, the power source terminal 50 is electrically connected to the device terminal 44, due to a predetermined pressing force being applied to the device terminal 44 and the power source terminal 50 by the coil spring 48. The battery pack 12 is thereby electrically connected to the electronic device module 13.

The circuit board 38 attached to the electronic device module 13 is electrically connected to the battery pack 12, due to the battery pack 12 being electrically connected to the electronic device module 13. The battery pack 12 is thereby electrically connected to the onboard charger 57, the DC/AC conversion unit 58 and the DC/DC conversion unit 59 provided on the circuit board 38. The electronic device module 13 is fixed to the vehicle 11 by a known technique such as bolting.

The PCU 14, the quick charger 15, the normal charger 16, the power outlet 17, the low voltage battery 24, the compressor 21, the water heater 22 and the optional device 23 are attached to the vehicle 11 by a known technique. The plurality of branch connectors 42 provided in the electronic device module 13 are respectively electrically connected to the PCU 14, the quick charger 15, the normal charger 16, the power outlet 17, the low voltage battery 24, the compressor 21, the water heater 22 and the optional device 23 by the wiring harnesses 54.

### Operation and Effect of Present Embodiment

Next, the operation and effect of the present embodiment will be described. The present embodiment relates to an electronic device module 13 for connecting to a battery pack 12 including a high voltage battery 20, the electronic device module 13 including a first conductive path 28 and a second conductive path 29 that are electrically connected to the battery pack 12, a branch part 37 electrically connected to the first conduction path 28 and the second conductive path 29, a plurality of branch paths 60 electrically connected to the branch part 37, a circuit board 38 electrically connected to at least one of the plurality of branch paths 60, and a plurality of branch connectors 42 electrically connected to the plurality of branch paths 60, and the circuit board 38 including a plurality of power conversion units 56 that convert power.

Also, in the present embodiment, the plurality of power conversion units 56 include an onboard charger 57 that is used for charging the high voltage battery 20, a DC/AC conversion unit 58 that converts direct current from the high voltage battery 20 into alternating current, and a DC/DC conversion unit 59 that converts a voltage of the direct current from the high voltage battery 20.

According to the present embodiment, the onboard charger 57, the DC/AC conversion unit 58 and the DC/DC conversion unit 59 can be electrically connected to the battery pack 12 by a single operation that involves connecting the battery pack 12 to the electronic device module 13. As a result, the connection workload can be reduced, compared to case where three operations are required in the case where the onboard charger 57, the DC/AC conversion unit 58 and the DC/DC conversion unit 59 are individually connected to the battery pack 12. If the number of power conversion units 56 that are provided on the circuit board 38 is increased, the effect of reducing the connection workload can be further enhanced.

Also, according to the present embodiment, the electronic device module 13 includes a power source control unit 32 that controls the high voltage battery 20. The high voltage battery 20 can thereby be connected to the power source control unit 32, by connecting the battery pack 12 to the electronic device module 13, thus enabling the workload for connecting the high voltage battery 20 to the power source control unit 32 to be reduced, compared to the case where the power source control unit 32 is arranged in a different position to the battery pack 12 and the electronic device module 13.

Also, according to the present embodiment, the electronic device module 13 includes a branch connector 42 that is electrically connected to a quick charger 15 for quickly charging the high voltage battery 20, and includes a first quick charging path 52 and a second quick charging path 53 that connect the branch connector 42 to the first conductive path 28 and second conductive path 29 electrically connected to the battery pack 12.

The branch part 37 for branching power from the high voltage battery 20 and the first quick charging path 52 and second quick charging path 53 for branching power from the high voltage battery 20 to the quick charger 15 can be formed together in the electronic device module 13, thus enabling the electronic device module 13 to be efficiently manufactured.

The power system 10 according to the present embodiment is provided with the electronic device module 13 and the battery pack 12 which is connected to the electronic device module 13 and includes the high voltage battery 20.

Also, according to the present embodiment, the battery pack 12 includes a power source connector 27, the electronic device module 13 includes a device connector 41 that fits together with the power source connector 27 in a fitting direction, the power source connector 27 includes a power source terminal 50 including a power source connection part 51 extending in a direction intersecting the fitting direction, the device connector 41 includes a device terminal 44 including a device connection part 45 extending in a direction intersecting the fitting direction, and the power source terminal 50 is electrically connected to the device terminal 44 by the power source connection part 51 elastically contacting the device connection part 45.

The battery pack 12 can be electrically connected to the electronic device module 13, by fitting the power source connector 27 and the device connector 41 together in the fitting direction, thus enabling the efficiency of the task of connecting the battery pack 12 to the electronic device module 13 to be improved.

Also, a wiring harness 54 for connecting the battery pack 12 to the electronic device module 13 is not required, thus enabling the power system 10 to be downsized.

### Embodiment 2

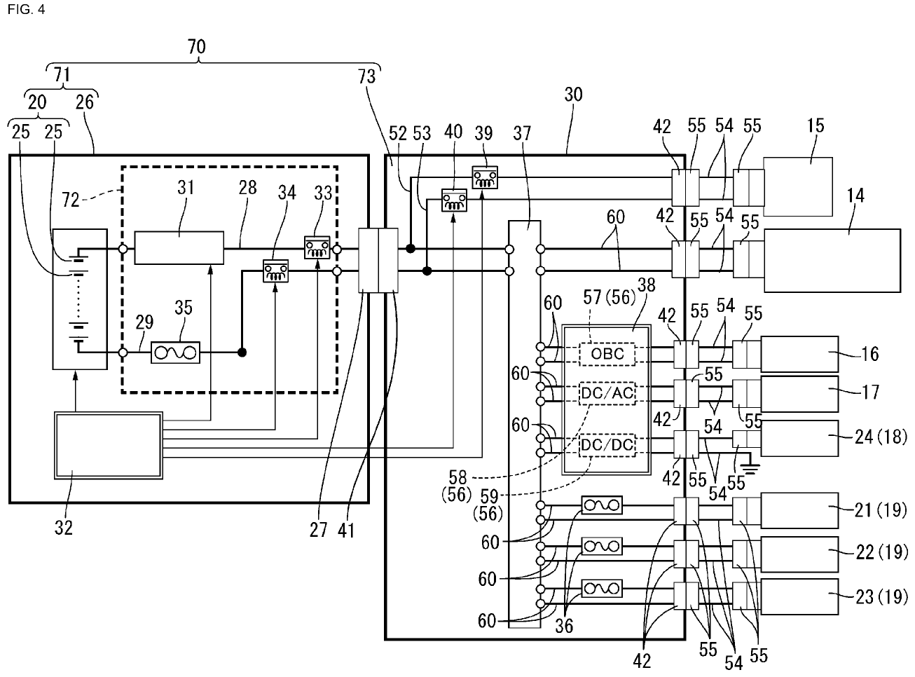

Next, Embodiment 2 of the present disclosure will be described with reference to FIG. 4. In a power system 70 according to the present embodiment, a high voltage junction box 72 is arranged between the high voltage battery 20 and the power source connector 27 in a battery pack 71. The high voltage junction box 72 includes the first conductive path 28, the second conductive path 29, the current sensor 31, the first system main relay 33, the main fuse 35 and the second system main relay 34.

The current sensor 31 and the first system main relay 33 are connected in series on the first conductive path 28. The first system main relay 33 is arranged between the current sensor 31 and the power source connector 27.

The main fuse 35 and the second system main relay 34 are connected in series on the second conductive path 29. The second system main relay 34 is arranged between the main fuse 35 and the power source connector 27.

The power source control unit 32 capable of communicating with the high voltage battery 20, the current sensor 31, the first system main relay 33, the second system main relay 34, the first quick charging relay 39, the second quick charging relay 40 and the circuit board 38 is arranged in the battery pack 71.

An electronic device module 73 according to the present embodiment includes the first conductive path 28, the second conductive path 29, the first quick charging path 52, the second quick charging path 53, the first quick charging relay 39, the second quick charging relay 40, the branch part 37, the circuit board 38, the fuses 36, the branch paths 60 and the branch connectors 42.

Because the configuration apart from the above is substantially similar to Embodiment 1, the same reference numerals are given to members that are the same, and redundant description is omitted.

According to the present embodiment, the electronic device module 73 can also be applied to the battery pack 71 in which the high voltage junction box 72 is arranged.

### Embodiment 3

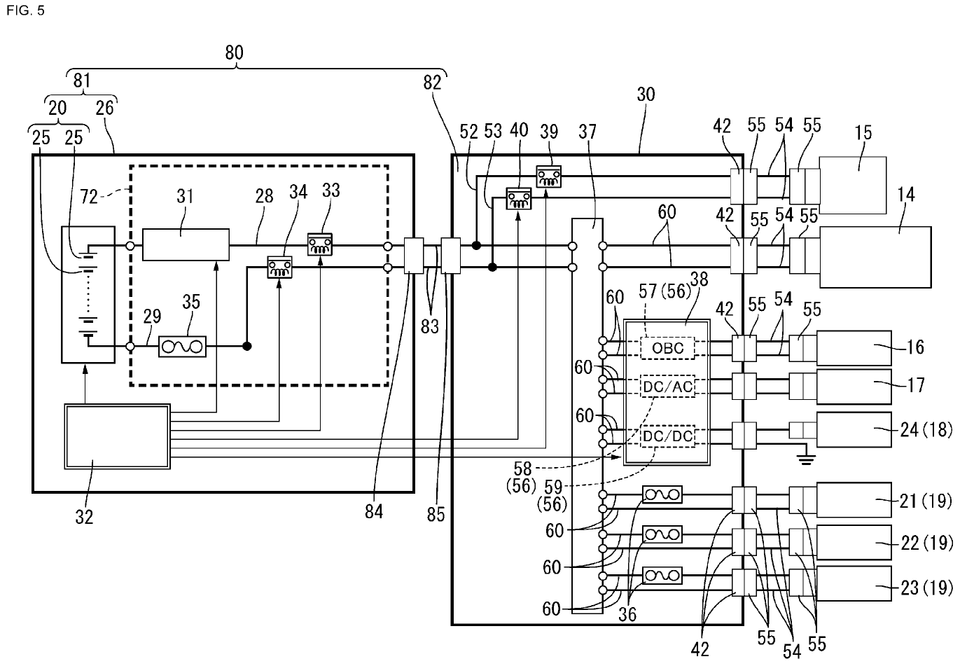

Next, Embodiment 3 of the present disclosure will be described with reference to FIG. 5. In a power system 80 according to the present embodiment, a power source connector 84 of a battery pack 81 and a device connector 85 of an electronic device module 82 are connected by a wiring harness 83.

Because the configuration apart from the above is substantially similar to Embodiment 2, the same reference numerals are given to members that are the same, and redundant description is omitted.

According to the above configuration, the electronic device module 82 can be disposed away from the battery pack 81 by setting the wiring harness 83 to any suitable length, thus enabling the housing space inside the vehicle 11 to be efficiently utilized.

### Embodiment 4

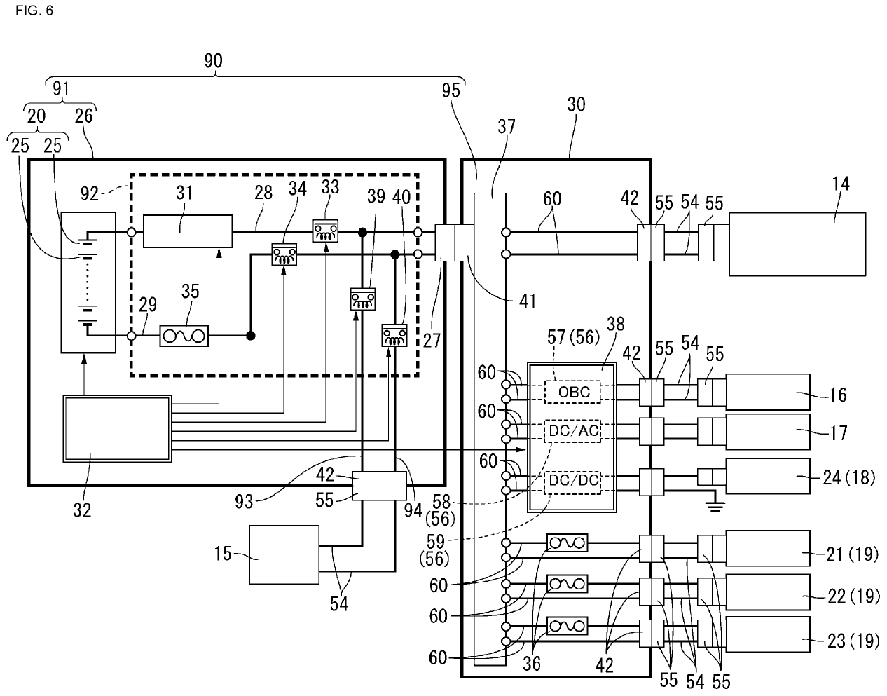

Next, Embodiment 4 of the present disclosure will be described with reference to FIG. 6. In a power system 90 according to the present embodiment, a high voltage junction box 92 is arranged between the high voltage battery 20 and the power source connector 27 in a battery pack 91. The high voltage junction box 92 includes the first conductive path 28, the second conductive path 29, the current sensor 31, the first system main relay 33, the main fuse 35, the second system main relay 34, the first quick charging path 52, the second quick charging path 53, the first quick charging relay 39 and the second quick charging relay 40.

The current sensor 31 and the first system main relay 33 are connected in series on the first conductive path 28. The first system main relay 33 is arranged between the current sensor 31 and the power source connector 27.

On the first conductive path 28, a first quick charging path 93 branches off between the first system main relay 33 and the power source connector 27. Also, on the second conductive path 29, a second quick charging path 94 branches off between the second system main relay 34 and the power source connector 27. The first quick charging path 93 and the second quick charging path 94 are electrically connected to the quick charger 15.

The first quick charging relay 39 is connected on the first quick charging path 93, and the second quick charging relay 40 is connected on the second quick charging path 94.

The case 26 of the battery pack 91 is provided with a branch connector 42 that is connected to the first quick charging path 93 and the second quick charging path 94. The branch connector 42 is connected to a connector 55 connected to one end of a wiring harness 54. A connector 55 connected to the other end of the wiring harness 54 is connected to the quick charger 15. Power is thereby supplied from the quick charger 15 to the high voltage battery 20.

The power source control unit 32 capable of communicating with the high voltage battery 20, the current sensor 31, the first system main relay 33, the second system main relay 34, the first quick charging relay 39, the second quick charging relay 40 and the circuit board 38 is arranged in the battery pack 91.

An electronic device module 95 according to the present embodiment includes the branch part 37, the circuit board 38, the fuses 36, the branch paths 60, and the branch connectors 42. In the present embodiment, the device connector 41 is directly connected to the branch part 37. In the present embodiment, the device connector 41 corresponds to a conductive path configured to be connected to the battery pack 91.

Because the configuration apart from the above is substantially similar to Embodiment 1, the same reference numerals are given to members that are the same, and redundant description is omitted.

According to the present embodiment, the electronic device module 95 can also be applied to the battery pack 91 that is connected to the quick charger 15.

A relatively large current flows through the first system main relay 33, the first quick charging relay 39, the second system main relay 34 and the second quick charging relay 40, and thus there tends to be increase in size. Space efficiency can be improved by disposing these members together in the high voltage junction box 92, thus enabling the power system 90 to be downsized as a whole.

### Embodiment 5

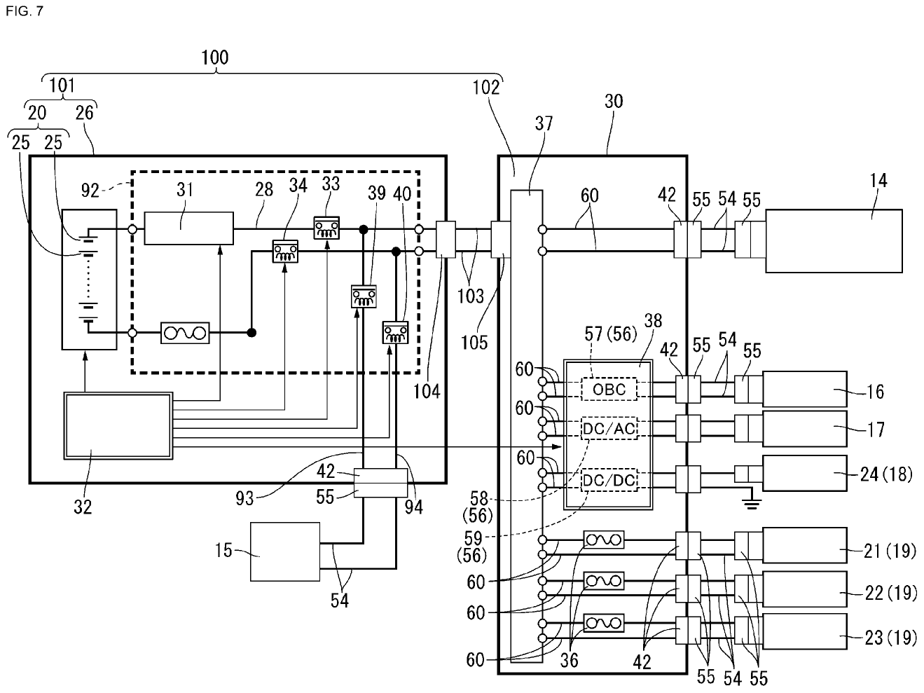

Next, Embodiment 5 of the present disclosure will be described with reference to FIG. 7. In a power system 100 according to the present embodiment, a power source connector 104 of a battery pack 101 is connected to a device connector 105 of an electronic device module 102 by a wiring harness 103.

Because the configuration apart from the above is substantially similar to Embodiment 4, the same reference numerals are given to members that are the same, and redundant description is omitted.

According to the above configuration, by setting the wiring harness 103 to any suitable length, the electronic device module 102 can be disposed away from the battery pack 101, thus enabling the housing space inside the vehicle 11 to be efficiently utilized.

### Embodiment 6

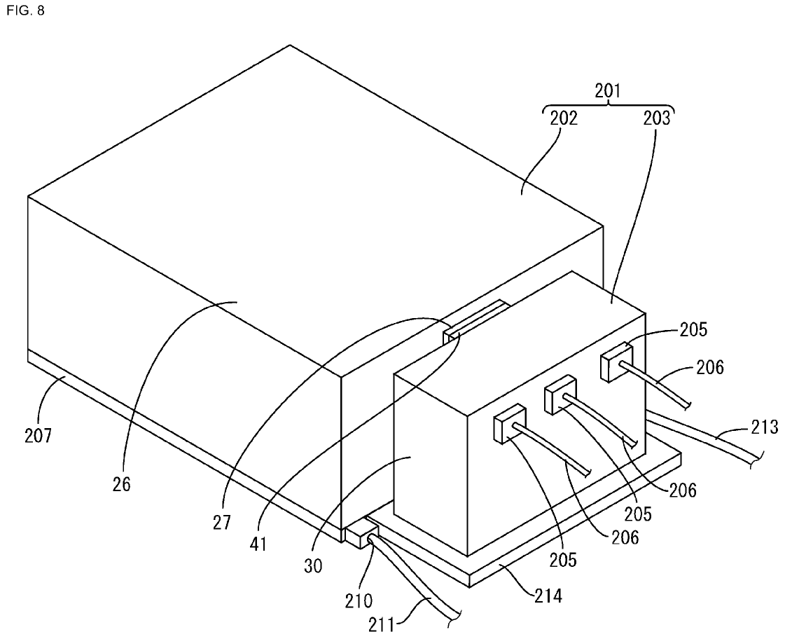

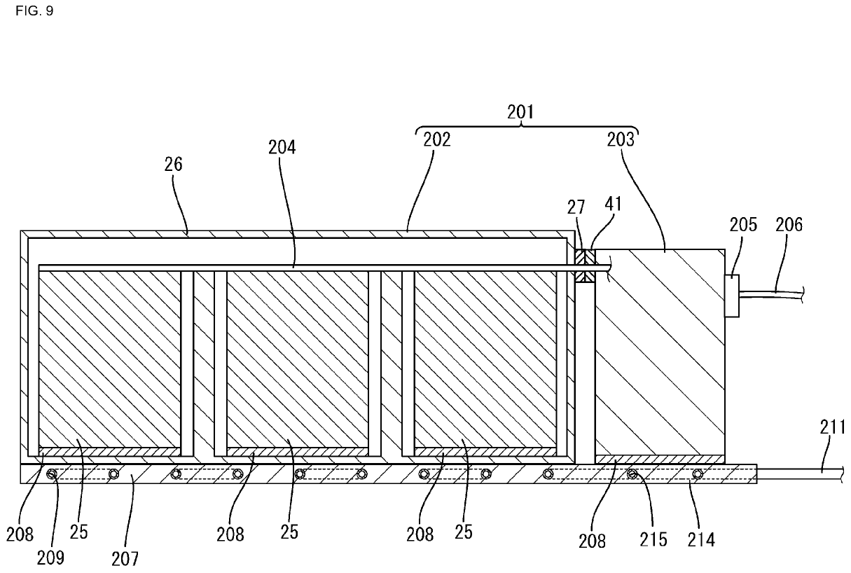

Next, Embodiment 6 of the present disclosure will be described with reference to FIGS. 8 to 11. As shown in FIG. 8, in a power system 201 according to the present embodiment, a battery pack 202 includes the case 26 and the power source connector 27 attached to the case 26. Also, an electronic device module 203 includes the case 30 and the device connector 41 attached to the case 30. As shown in FIG. 9, by connecting the power source connector 27 of the battery pack 202 to the device connector 41 of the electronic device module 203, a conductive path 204 arranged inside the battery pack 202 and electrically connected to the power storage element 25 is electrically connected to the electronic device module 203.

As shown in FIG. 8, a plurality (three in the present embodiment) of connectors 205 are attached to the case 30 of the electronic device module 203. A wiring harness 206 is connected to each connector 205. The wiring harnesses 206 are electrically connected to an external circuit.

The power system 201 includes a battery cooling unit 207 that cools the battery pack 202. The battery pack 202 is placed on the upper surface of the battery cooling unit 207. The case 26 of the battery pack 202 is thermally connected to the battery cooling unit 207 that cools the battery pack 202. Thermally connected means that heat can move between the case 26 of the battery pack 202 and the battery cooling unit 207. The outer surface of the case 26 of the battery pack 202 may be in contact with or may be spaced away from the outer surface of the battery cooling unit 207. In the present embodiment, the outer surface of the case 26 of the battery pack 202 is in contact with the outer surface of the battery cooling unit 207.

As shown in FIG. 9, inside the case 26 of the battery pack 202, a heat transfer sheet 208 is interposed between the power storage element 25 and a bottom wall of the case 26. The heat transfer sheet 208 is a synthetic resin sheet having a higher thermal conductivity than air. Heat generated by the power storage element 25 is thereby transferred to the case 26 via the heat transfer sheet 208.

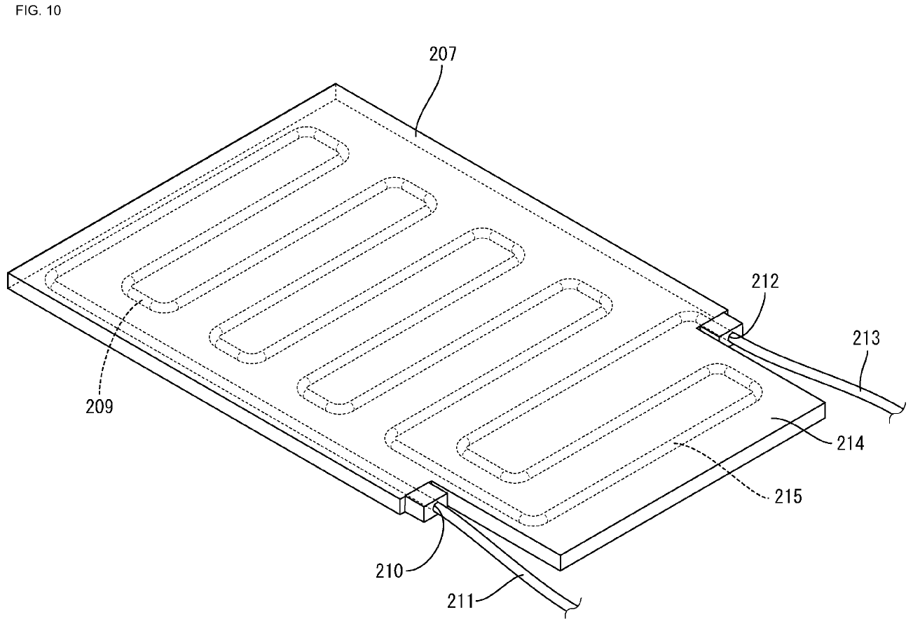

As shown in FIG. 10, the battery cooling unit 207 has a flat plate shape. Viewed from above, the size of the battery cooling unit 207 is substantively the same as the battery pack 202 (see FIG. 8). Substantively the same includes the case where the size of the battery pack 202 is the same as the size of the battery cooling unit 207 viewed from above, and also the case where the size of the battery pack 202 may differ from the size of the battery cooling unit 207 but can be recognized as being substantively the same. In the present embodiment, the battery cooling unit 207 has a rectangular shape viewed from above.

As shown in FIG. 9, a first flow path 209 through which coolant (not shown) flows is formed inside the battery cooling unit 207. The first flow path 209 has a tubular shape having a circular cross section. The first flow path 209 is disposed in a bent state inside the battery cooling unit 207 (see FIG. 10).

As shown in FIG. 10, an inflow port 210 for the coolant to flow into the first flow path 209 is open in a side edge of the case 26 of the battery cooling unit 207. An inflow path 211 is connected to the inflow port 210. Also, an outflow port 212 for the coolant to flow out from the first flow path 209 is open in a side edge of the case 26 of the battery cooling unit 207. An outflow path 213 is connected to the outflow port 212. The inflow path 211 and the outflow path 213 may be metal or synthetic resin pipes, or may be tubes having rubber elasticity. In the present embodiment, the inflow port 210 and the outflow port 212 are formed in the same side edge of the case 26. The inflow port 210 and the outflow port 212 may also be provided in different side edges of the case 26.

As the coolant that flows through the first flow path 209, a known coolant such as water, alcohol, oil, air or a fluorine inert liquid can be selected as appropriate.

Heat transferred to the case 26 of the battery cooling unit 207 is transferred to the first flow path 209, and is then transferred to the coolant flowing through the first flow path 209. The coolant flows through the first flow path 209, and flows out through the outflow port 212. The heat transferred from the power storage element 25 to the battery cooling unit 207 is thereby transferred in order of the power storage element 25, the heat transfer sheet 208 and the coolant, and moves outside through the outflow port 212.

As shown in FIG. 8, the battery cooling unit 207 is provided with a module cooling unit 214 that protrudes from a side edge on the electronic device module 203 side, when the battery pack 202 is connected to the electronic device module 203. In the present embodiment, the battery cooling unit 207 and the module cooling unit 214 are integrally formed. The electronic device module 203 is placed on an upper surface of the module cooling unit 214 via the heat transfer sheet 208.

The case 30 of the electronic device module 203 is thermally connected to the module cooling unit 214 that cools the electronic device module 203. Thermally connected means that heat can move between the case 30 of the electronic device module 203 and the module cooling unit 214. The outer surface of the case 30 of the electronic device module 203 may be in contact with or may be spaced away from the outer surface of the module cooling unit 214. In the present embodiment, the outer surface of the case 30 of the electronic device module 203 is in heat transferable contact with the outer surface of the module cooling unit 214 via the heat transfer sheet 208.

The module cooling unit 214 has a flat plate shape in the up-down direction. Viewed from above, the module cooling unit 214 is formed larger than the electronic device module 203. In the present embodiment, the module cooling unit 214 has a rectangular shape viewed from above.

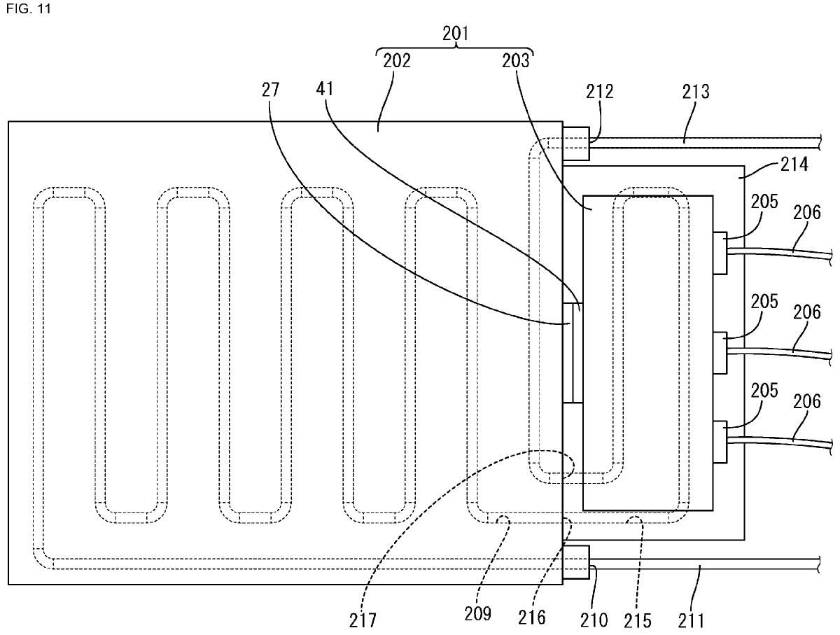

As shown in FIG. 11, a second flow path 215 through which coolant flows is formed inside the module cooling unit 214. The second flow path 215 has a tubular shape having a circular cross section. The second flow path 215 is disposed in a bent state inside the module cooling unit 214. In the present embodiment, the second flow path 215 is formed continuously with the first flow path 209. A coupling portion 216 coupling the first flow path 209 and the second flow path 215 and a coupling portion 217 coupling the second flow path 215 and the first flow path 209 are provided between the inflow port 210 and the outflow port 212. The coolant thereby flows in order of the inflow port 210, the first flow path 209, the coupling portion 216 coupling the first flow path 209 and the second flow path 215, the second flow path 215, the coupling portion 217 coupling the second flow path 215 and the first flow path 209, the first flow path 209, and the outflow port 212.

Heat generated in the electronic device module 203 is transferred from the case 30 of the electronic device module 203 to the module cooling unit 214. The heat transferred to the module cooling unit 214 is transferred from the second flow path 215 to the coolant, flows from the coupling portion 217 coupling the second flow path 215 and the first flow path 209 to the first flow path 209, and moves outside through the outflow port 212.

Because the configuration apart from the above is substantially similar to Embodiment 1, the same reference numerals are given to members that are the same, and redundant description is omitted.

According to the present embodiment, the battery pack 202 is in heat transferable contact with the battery cooling unit 207 that cools the battery pack 202, the first flow path 209 through which the coolant flows is provided inside the battery cooling unit 207, the electronic device module 203 is in heat transferable contact with the module cooling unit 214 that cools the electronic device module 203, and the module cooling unit 214 is provided with the second flow path 215 through which the coolant flowing out of the flow path of the battery cooling unit 207 flows.

Heat generated by the power storage element 25 is transferred from the battery pack 202 to the battery cooling unit 207, and is transferred to the coolant flowing through the first flow path 209 provided in the battery cooling unit 207. The temperature of the power storage element 25 can thereby be lowered. Next, the coolant flowing out from the first flow path 209 flows into the second flow path 215. In the module cooling unit 214 in which the second flow path 215 is provided, heat generated by the electronic device module 203 is transferred to the module cooling unit 214, and is thereafter transferred to the coolant flowing through the second flow path 215. The temperature of the electronic device module 203 can thereby be reduced. In the present embodiment, the coolant for cooling the module cooling unit 214 can also be used in the battery cooling unit 207 as a coolant for cooling the power storage element 25. The electronic device module 203 can thereby be efficiently cooled.

Also, in the present embodiment, the battery cooling unit 207 and the module cooling unit 214 are integrally formed. The number of components can thereby be reduced.

### Embodiment 7

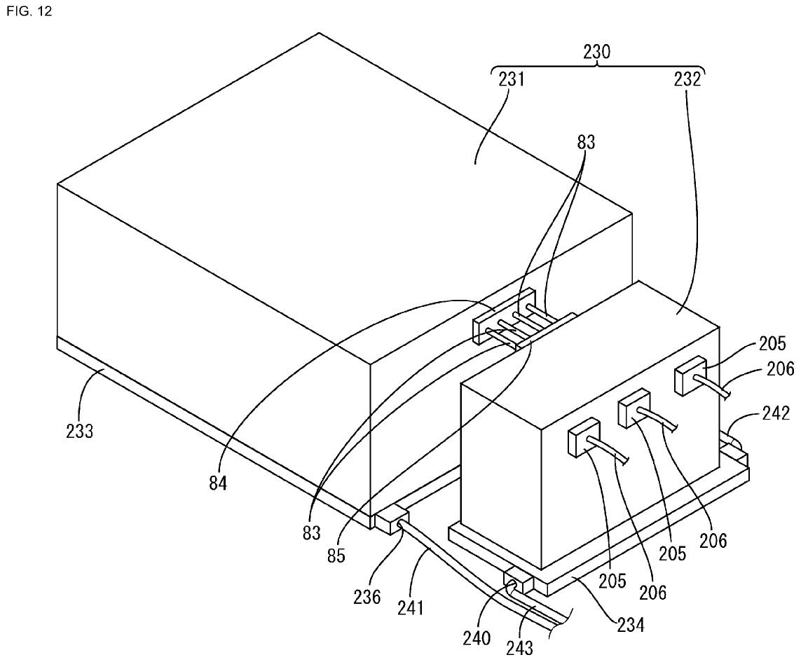

Next, Embodiment 7 of the present disclosure will be described with reference to FIGS. 12 to 14. As shown in FIG. 12, in a power system 230 according to the present embodiment, a power source connector 84 of a battery pack 231 is connected to a device connector 85 of an electronic device module 232 by a plurality (four in the present embodiment) of wire harnesses 83. Also, a battery cooling unit 233 that cools the battery pack 231 and a module cooling unit 234 that cools the electronic device module 232 are separate components.

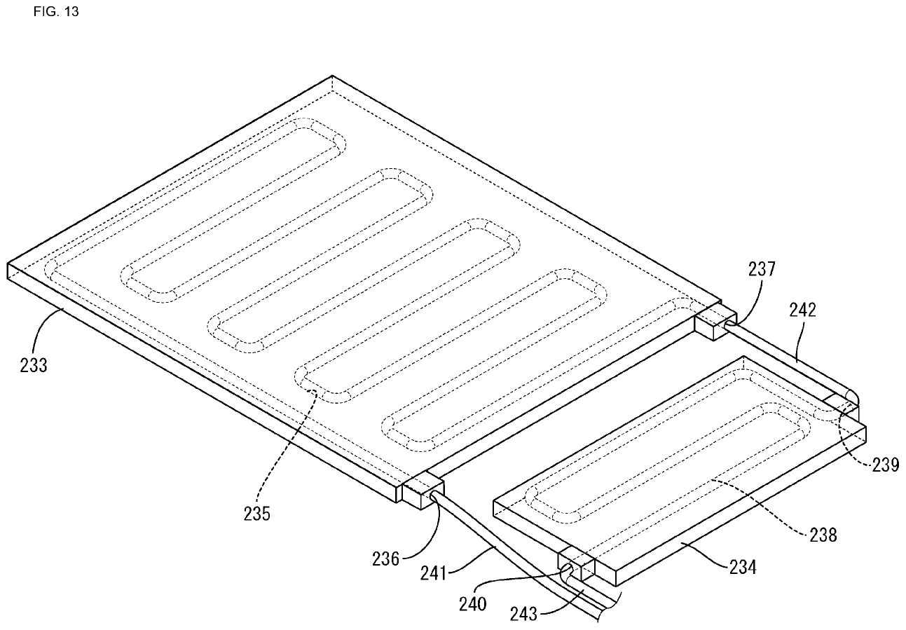

As shown in FIG. 13, the battery cooling unit 233 includes a first inflow port 236 through which coolant flows into the first flow path 235 and a first outflow port 237 through which coolant flows out from the first flow path 235. Also, the module cooling unit 234 includes a second inflow port 239 through which coolant flows into the second flow path 238 and a second outflow port 240 through which coolant flows out from the second flow path 238.

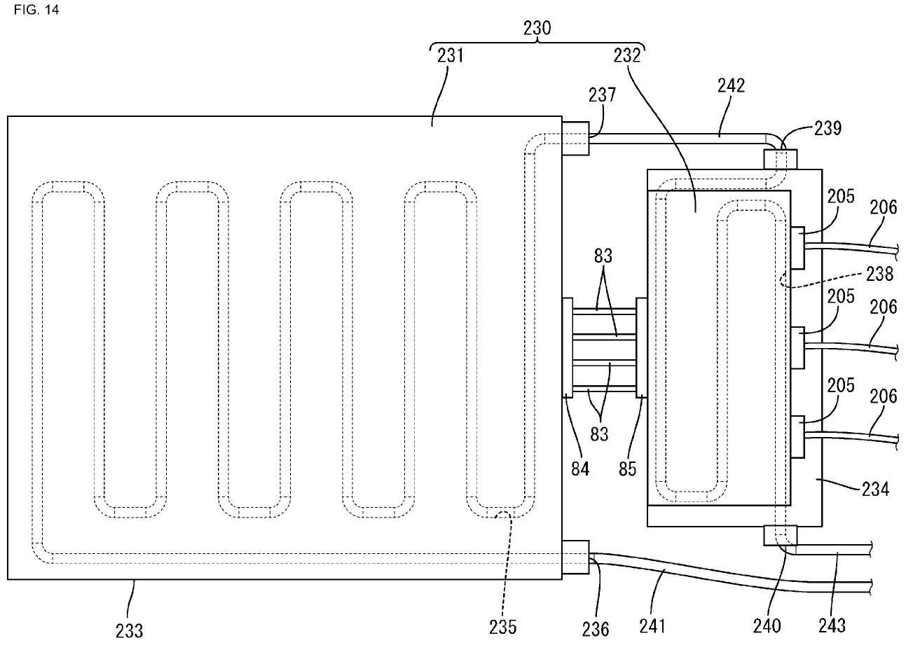

As shown in FIGS. 13 and 14, an inflow path 241 is connected to the first inflow port 236, and one end of a relay path 242 is connected to the first outflow port 237. The other end of the relay path 242 is connected to the second inflow port 239. The coolant flowing out from the first outflow port 237 thereby flows into the second inflow port 239. An outflow path 243 is connected to the second outflow port 240 of the module cooling unit 234. The coolant flows in order of the inflow path 241, the first inflow port 236, the first flow path 235, the first outflow port 237, the relay path 242, the second inflow port 239, the second flow path 238, the second outflow port 240 and the outflow path 243. The inflow path 241, the relay path 242 and the outflow path 243 may be metal or synthetic resin pipes, or may be tubes having rubber elasticity.

Because the configuration apart from the above is substantially similar to Embodiment 6, the same reference numerals are given to members that are the same, and redundant description is omitted.

According to the present embodiment, the battery cooling unit 233 and the module cooling unit 234 are separate components, the battery cooling unit 233 includes the first inflow port 236 through which coolant flows into the first flow path 235 and the first outflow port 237 through which coolant flows out from the first flow path 235, and the module cooling unit 234 includes the second inflow port 239 through which coolant flowing out through the first outflow port 237 flows into the second flow path 238 and the second outflow port 240 through which coolant flows out from the second flow path 238.

According to the above configuration, the battery pack 231 and the battery cooling unit 233 can be disposed in a different place to the electronic device module 232 and the module cooling unit 234. Design freedom can thereby be improved with regard to disposition of the battery pack 231 and battery cooling unit 233 and the electronic device module 232 and module cooling unit 234.

Also, the electronic device module 232 is cooled by the coolant flowing out from the first flow path 235 of the battery cooling unit 233 that cools the power storage element 25, thus enabling a reduction in the cooling efficiency of the power storage element 25 to be suppressed.

### OTHER EMBODIMENTS

The member for connecting the electronic device module to the various devices is not limited to a wire harness, and may be a bus bar made of a metal plate material.

The voltage of the low voltage battery 24 is not limited to 12 V, and can be any suitable voltage such as 48 V.

The low voltage device 18 is not limited to the low voltage battery 24, and any suitable electrical device can be used.

The circuit board 38 need only be provided with two or more types of power conversion units 56, and is not limited to the onboard charger 57, the DC/AC conversion unit 58 and the DC/DC conversion unit 59.

The connection structure for connecting the power source terminal 50 and the device terminal 44 is not limited, and any suitable technique can be employed, such as connection using nuts and bolts, for example.

1. An electronic device module for connecting to a battery pack including a high voltage battery, comprising:
a conductive path configured to be electrically connected to the battery pack;
a branch part electrically connected to the conductive path;
a plurality of branch paths electrically connected to the branch part;
a circuit board electrically connected to at least one of the plurality of branch paths; and
a plurality of branch connectors electrically connected to the plurality of branch paths,
wherein the circuit board includes a plurality of power conversion units configured to convert power.

2. The electronic device module according to claim 1, wherein the plurality of power conversion units are one or more of an onboard charger configured to be used for charging the high voltage battery, a DC/AC conversion unit configured to convert direct current from the high voltage battery into alternating current, and a DC/DC conversion unit configured to convert a voltage of the direct current from the high voltage battery.

3. The electronic device module according to claim 1, further including:
a power source control unit configured to control the high voltage battery.

4. The electronic device module according to claim 1, further including:
a branch connector configured to be electrically connected to a quick charger for quickly charging the high voltage battery; and
a quick charging path connecting the branch connector to the conductive path configured to be electrically connected to the battery pack.

5. A power system comprising:
the electronic device module according to claim 1; and
a battery pack connected to the electronic device module and including a high voltage battery.

6. The power system according to claim 5,
wherein the battery pack includes a power source connector,
the electronic device module includes a device connector fitted together with the power source connector in a fitting direction;
the power source connector includes a power source terminal including a power source connection part extending in a direction intersecting the fitting direction,
the device connector includes a device terminal including a device connection part extending in a direction intersecting the fitting direction, and
the power source terminal and the device terminal are electrically connected due to the power source connection part and the device connection part elastically contacting each other.

7. The power system according to claim 5,
wherein the battery pack is in heat transferable contact with a battery cooling unit configured to cool the battery pack,
the battery cooling unit is provided with a first flow path through which a coolant flows,
the electronic device module is in heat transferable contact with a module cooling unit configured to cool the electronic device module, and
the module cooling unit is provided with a second flow path into which the coolant flowing out from the first flow path of the battery cooling unit flows.

8. The power system according to claim 7, wherein the battery cooling unit and the module cooling unit are integrally formed.

9. The power system according to claim 7,
wherein the battery cooling unit and the module cooling unit are separate components,
the battery cooling unit includes a first inflow port through which the coolant flows into the first flow path, and a first outflow port through which the coolant flows out from the first flow path, and
the module cooling unit includes a second inflow port through which the coolant flowing out through the first outflow port flows into the second flow path, and a second outflow port through which the coolant flows out from the second flow path.

10. The electronic device module according to claim 2, further including:
a power source control unit configured to control the high voltage battery.

11. The electronic device module according to claim 2, further including:
a branch connector configured to be electrically connected to a quick charger for quickly charging the high voltage battery; and
a quick charging path connecting the branch connector to the conductive path configured to be electrically connected to the battery pack.

12. The electronic device module according to claim 3, further including:
a branch connector configured to be electrically connected to a quick charger for quickly charging the high voltage battery; and
a quick charging path connecting the branch connector to the conductive path configured to be electrically connected to the battery pack.

13. A power system comprising:
the electronic device module according to claim 2; and
a battery pack connected to the electronic device module and including a high voltage battery.

14. A power system comprising:
the electronic device module according to claim 3; and
a battery pack connected to the electronic device module and including a high voltage battery.

15. A power system comprising:
the electronic device module according to claim 4; and
a battery pack connected to the electronic device module and including a high voltage battery.

16. The power system according to claim 6,
wherein the battery pack is in heat transferable contact with a battery cooling unit configured to cool the battery pack,
the battery cooling unit is provided with a first flow path through which a coolant flows,
the electronic device module is in heat transferable contact with a module cooling unit configured to cool the electronic device module, and
the module cooling unit is provided with a second flow path into which the coolant flowing out from the first flow path of the battery cooling unit flows.
